(19) United States
(12) Patent Application Publication
(10) Pub. No.: US 2022/0190311 A1
(43) Pub. Date: Jun. 16, 2022

(54) SOLUTION-PHASE ELECTRODEPOSITION OF ARTIFICIAL SOLID ELECTROLYTE INTERPHASE (SEI) LAYERS ON BATTERY ELECTRODES

(71) Applicant: Coreshell Technologies, Inc., San Leandro, CA (US)

(72) Inventors: Sourav Roger Basu, Oakland, CA (US); Jonathan Tan, San Leandro, CA (US)

(21) Appl. No.: 17/438,311

(22) PCT Filed: Mar. 11, 2020
(86) PCT No.: PCT/US2020/021995

§ 371 Date: Sep. 10, 2021

Related U.S. Application Data
(60) Provisional application No. 62/816,510, filed on Mar. 11, 2019.

(51) Int. Cl. H01M 4/04; H01M 4/587; H01M 4/505; H01M 4/525

(52) U.S. Cl. CPC H01M 4/0452; H01M 4/587; H01M 4/0471; H01M 4/525; H01M 4/505

(57) ABSTRACT

Methods, systems, and related aspects for solution -phase electrodeposition of artificial solid- electrolyte interphase (SEI) layers coated onto battery electrodes. In certain aspects, such a method comprises: (a) providing the battery electrode onto a conveyance apparatus; (b) transferring, by the conveyance apparatus, the battery electrode to an electrodeposition chamber containing a liquid solution comprising a first reagent and an electrolyte; exposing the battery electrode to the liquid solution; and applying a voltage or current to the battery electrode relative to a counter electrode exposed to the liquid solution for a predetermined amount of time, thereby yielding a coated battery electrode comprising the artificial SEI.

### CROSS-REFERENCE TO RELATED APPLICATIONS

This application claims the benefit of U.S. Provisional Application No. 62/816,510, filed on Mar. 11, 2019, which is incorporated by reference herein for all purposes.

### FIELD

Embodiments of the present disclosure generally relate to various materials, which, when grown on the surface of battery electrodes, via solution-phase electrodeposition techniques, passivate their surfaces against degrading reactions during operation.

### BACKGROUND

Traditional vapor phase atomic layer deposition (ALD) techniques rely on the evaporation of metalorganic precursors in an evacuated chamber. Substrates placed within this chamber are exposed to the impinging flux of metalorganic vapor. Substrate surfaces, which are often hydroxyl-terminated, react with impinging vapor to produce precisely one self-limiting, surface-saturating monolayer of adsorbed metalorganic. In one instance, metalorganic adsorption, followed by purge of excess metalorganic using vacuum and inert gas, followed by exposure of substrate surface to an oxidizer (such as H₂O, O₂ or O₃) results in the formation of precisely one monolayer of metal oxide.

ALD is particularly well-suited for generating conformal coatings with precise thicknesses on substrates possessing a porous microstructure. One example of such a substrate is a lithium-ion battery (LIB) electrode. State-of-the-art LIB electrodes are typically fabricated by coating slurries of anode or cathode particles mixed with binder and conductive additive onto foil current collectors. The open space remaining between particles after coating generates porosity throughout the thickness of electrode films. Substrates possessing this kind of morphology often cannot be adequately coated by other physical vapor deposition (PVD) processes (such as sputtering) because of “line-of-sight” limitations. Typically, deposition cycles in such techniques allow for little surface mobility of adsorbed atoms before reaction to complete product. As a result, only regions of substrate that are directly exposed to impinging flux of atoms are adequately coated. To conformally and uniformly coat all surfaces within a porous morphology, a deposition technique akin to ALD is required, where substantial time is allowed for surface mobility of adsorbed atoms prior to reaction. ALD coatings on lithium-ion battery electrodes have been demonstrated to reduce deleterious side reactions typically associated with capacity fade such as solid-electrolyte-interphase (SEI) formation. However, numerous manufacturing limitations of traditional ALD processes present a need for a more manufacturable process that achieves similar film quality, uniformity and conformality.

While metalorganic reagents (i.e., precursors) used in ALD of oxides such as Al₂O₃ and ZnO (trimethylaluminum (TMA) and diethylzinc (DEZ), respectively) evaporate at relatively low temperatures (<100° C.) and at modest base vacuum pressures (>1 Torr), most metalorganic precursors require temperatures greater than 100° C. (and many greater than 200° C.) to yield a substantial vapor pressure. The key drawback to high precursor boiling point is that the substrate temperature must also be maintained above the precursor boiling point to prevent condensation of precursor on substrate surfaces. Precursor condensation results in loss of monolayer-by-monolayer growth control, which in turn results in unpredictable final film thickness. Substrates in an evacuated ALD chamber also often need to be heated radiatively (as with suspended roll-to-roll foil substrates), due to the lack of a heat transfer medium. Radiative heating is inefficient for reflective foil substrates such as those used in battery electrodes. High substrate temperatures (>200° C.) are also impractical for battery electrodes because polymer binders (such as PVDF) used in electrode coating can degrade at such temperatures. Residual gases trapped within layers of roll-to-roll substrates also lengthen pump down time in traditional ALD chambers, and the loss of unused precursor through continuous purge and evacuation result in poor materials utilization in traditional ALD processes. The pyrophoric nature of the gaseous metalorganic precursors typically used in traditional ALD processes also requires the incorporation of costly safety infrastructure.

In U.S. PGPUB 2016/0351973, vapor phase ALD and derivative deposition technologies were disclosed to reduce SEI formation by directly coating battery electrode constituent powders with various encapsulating coatings prior to slurry formation. Such a technology avoids certain limitations of ALD coating of formed electrodes such as substrate temperature. However, a key shortcoming of this technology is that the passivating layers formed in this manner introduce substantial electrode internal resistance. Internal resistance can greatly limit battery power output due to voltage drop. In order for an encapsulating, passivating layer to function well as an inhibitor to deleterious side reactions, it must inhibit electron transfer between electrode and electrolyte. Wide band-gap insulating materials, as indicated in the '973 application, are good candidates for such an application. Unfortunately, when applied to individual electrode powder particles, they will also impede particle-to-particle electron transfer, which will result in internal resistance. The only way to circumvent the issue of internal resistance while maintaining the benefit of a passivating layer between electrode and electrolyte is to deposit the passivating layer on a pre-formed battery electrode.

High quality, conformal thin films of metals, oxides and chalcogenides, among other sets of compounds, have been deposited for decades by solution-phase electrodeposition. In the electrodeposition technique, a substrate is exposed to a solution of cations and/or anions within an electrolyte. The substrate is then anodically or cathodically electrically polarized versus a counter electrode; the polarization drives ions to or from the substrate, depending on the direction of polarization. Upon reaching the surface of the substrate, electron transfer to/from the cation/anion to the substrate can result in the precipitation of solid elements or compounds, depending on the reactants employed. As an example, the reductive electrodeposition of a generic metal M can be approximated by the following chemical reaction:

M⁺+xe⁻M (s) E=E⁰ (Equation 1)

where x represents the oxidation state of the metal M in solution, and E⁰ represents the standard reduction potential of M versus a given reference electrode. The result of such a reaction is the precipitation of a solid film composed entirely of metal M.

In other instances, two or more elements may electrodeposit on a given substrate simultaneously, if the potential of a given substrate that is exposed to these elements is adjusted such that it is thermodynamically favorable for the two or more elements to simultaneously precipitate. Such elements may then react to form a compound or may alloy with each other. As an example, the semiconducting compound CdSe may be electrodeposited from a solution of a Cd source (such as CdSO₄) and a Se source (such as SeO₂), if the substrate potential is sufficiently low enough to promote precipitation of both Cd and Se. The elements Cd and Se will then react to generate the compound CdSe during electrodeposition.

Given that the electrodeposition process requires charge transfer at an interface between a solid substrate and an electrolyte possessing dissolved components, in order to precipitate a solid product on the substrate composed of such dissolved components, electrodeposited solid products are likely to form anywhere that the substrate is physically contacting the aforementioned electrolyte. As such, complicated substrate morphologies (such as substrates composed of highly porous microstructures or high-aspect-ratio features) can be uniformly and conformally coated using an electrodeposition technique, as long as all surfaces within a substrate microstructure (that are desired to be coated) are in physical contact with the electrolyte, while also being electrically connected to a source/sink of electrons.

As a result, electrodeposition provides a great advantage over other thin film deposition techniques in that it is capable of conformally coating porous substrates (such as lithium-ion battery electrodes) while also being atmospheric and low-cost. Thus far, to date, only ALD has been demonstrated to achieve conformal growth of thin film protective coatings on porous, formed lithium-ion battery electrodes. However, roll-to-roll ALD has yet to be demonstrated as a commercially viable process. Requirements of high deposition zone vacuum, high source and substrate temperature to prevent precursor condensation, and limited selection of precursors for the deposition of various materials renders roll-to-roll ALD impractical for implementation in high-volume, state-of-the-art LIB manufacturing. Consequently, a need exists to apply protective coatings to the surface of lithium-ion battery electrodes using a technique that can be more feasibly introduced into a LIB manufacturing process as compared to roll-to-roll ALD. Electrodeposition is uniquely suited to satisfy this need, as LIB electrodes are both adequately electrically conductive to promote uniform coating via electrodeposition, as well as composed of porous and tortuous networks that are incapable of being coated by other standard PVD “line-of-sight” techniques.

### SUMMARY

Systems and methods as provided herein relate to solution-phase electrodeposition of novel materials (in the form of thin film coatings) on the surface of lithium-ion battery electrodes. Such techniques are more commercially and technically feasible for introduction into high-volume lithium-ion battery (LIB) manufacturing than roll-to-roll ALD or other high-vacuum, vapor deposition processes.

In certain aspects, the present disclosure relates to a method for coating an artificial solid-electrolyte interphase (“SEI”) onto a surface of a battery electrode, comprising:
(a) providing a battery electrode onto a conveyance apparatus;
(b) transferring, by the conveyance apparatus, the battery electrode to an electrodeposition chamber comprising at least a liquid solution comprising an at least first reagent;
(c) submerging the battery electrode in the liquid solution;
(d) applying a voltage or current to the battery electrode relative to a counter electrode also exposed to the liquid solution, resulting in a solid-precipitating reaction on the battery electrode, thereby generating the artificial SEI on the surface of the battery electrode.

In certain embodiments, the artificial SEI layer has a thickness from about 0.5 nm to 100 μm. In some embodiments, the monolayer of artificial SEI may be composed of grains having a size 0.5 nm to 100 μm. In other embodiments, the artificial SEI may be crystalline or amorphous.

In certain embodiments, the battery electrode is composed of an “active material”, which is the portion of the electrode that inserts/de-inserts lithium during charging/discharging, respectively, and a “substrate”, which is typically a flexible conductive current collector on which the “active material” is deposited. Other battery electrode constituent materials may include an adhesive binder and an electrically conductive additive.

In certain embodiments, the battery electrode has a thickness of 100 nm to 1,000 μm. In other embodiments, the battery electrode to be coated has pores ranging in size of 0.1 nm to 100 μm. In some embodiments, the battery electrode to be coated has a film porosity of 1-99%. In some embodiments, the battery electrode active material is composed of graphite, Si, Sn, Ge, Al, P, Zn, Ga, As, Cd, In, Sb, Pb, Bi, SiO, SnO₂, a Si-graphite composite, a Sn-graphite composite or lithium metal. In other embodiments, the battery electrode is composed of LiNiₓMn_{y}Co_{z}O₂, LiNiₓCo_{y}Al_{z}O₂, LiMn_{y}Ni_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

In certain embodiments, the battery electrode is a lithium-ion battery electrode.

In certain embodiments, the electrodes are fully-formed (also referred herein as “pre-formed”). Full-forming an electrode refers to a standard sequence of electrode forming processes, including but not limited to, casting of slurries of active and inactive material components onto a foil substrate to form an electrode, followed by drying of the electrode, followed by calendaring of the electrode. In some embodiments, full-forming of an electrode does not include calendaring.

In certain embodiments, the substrate may be a continuous substrate, typically in the form of a long foil or sheet. A “continuous substrate” as used herein refers to a substrate that possesses an aspect ratio of at least 10:1 between its two largest dimensions, and is sufficiently flexible so as to be wound onto itself in the form of a roll. It may be made up of various materials, including but not limited to metal, such as copper, aluminum, or stainless steel, or an organic material, such as polyimide, polyethylene, polyether ether ketone (PEEK), or polyester, polyethylene napthalate (PEN).

In certain embodiments, the conveyance apparatus may be a roll-to-roll deposition system. In some embodiments, the conveyance apparatus comprises a series of rollers for guiding the battery electrode to the electrodeposition chamber.

In certain embodiments, the method further comprises rinsing the coated battery electrode post-deposition with a rinsing solution comprising at least a solvent.

In certain embodiments, the method further comprises exposing the coated battery electrode comprising the artificial SEI to a thermal treatment in the presence of an ambient comprising a defined composition of gases. In some embodiments these gases may be a mixture of O₂, ozone, N₂, Ar. In some embodiments the coated battery electrode may be heated to temperatures up to 300 degrees within the presence of gases. In some embodiments the coated battery electrode may be heated while being exposed to a plasma comprising oxygen, argon, hydrogen or nitrogen. In some embodiments, the thermal treatment step occurs in a thermal reaction chamber, such as an oven.

In some embodiments, the uncoated battery electrode may be exposed to thermal treatments in the presence of gases or plasma prior to coating via electrodeposition.

In certain embodiments, the liquid solution comprises an electrolyte, which further comprises a solvent and a salt. In certain embodiments the solvent further comprises an organic solvent, an ionic liquid, water or a mixture of the aforementioned. In certain embodiments the salt further comprises a lithium-containing compound such as LiClO₄. In certain embodiments, the electrolyte does not comprise a salt. In certain embodiments the electrolyte comprises a solvent and the artificial SEI-forming reactants.

In certain embodiments, the artificial SEI comprises a compound selected from one of the following groups:
(a) binary oxides of type AₓO_{y}, where A is an alkali metal, alkali-earth metal, transition metal, semimetal or metalloid and x and y are stoichiometric coefficients;
(b) ternary oxides of type AₓB_{y}O_{z}, where A and B are any combination of alkali metal, alkali-earth metal, transition metal, semimetal or metalloid and x, y and z are stoichiometric coefficients;
(c) quaternary oxides of type A_{w}BₓC_{y}O_{z}, where A, B and C are any combination of alkali metal, alkali-earth metal, transition metal, semimetal or metalloid and w, x, y and z are stoichiometric coefficients;
(d) binary halides of type AₓB_{y}, where A is an alkali metal, alkali-earth metal, transition metal, semimetal or metalloid, B is a halogen and x and y are stoichiometric coefficients;
(e) ternary halides of type AₓB_{y}C_{z}, where A and B are any combination of alkali metal, alkali-earth metal, transition metal, semimetal or metalloid, C is a halogen and x, y and z are stoichiometric coefficients;
(f) quaternary halides of type A_{w}BₓC_{y}D_{z}, where A, B and C are any combination of alkali metal, alkali-earth metal, transition metal, semimetal or metalloid, D is a halogen and w, x, y and z are stoichiometric coefficients;
(g) binary nitrides of type AₓN_{y}, where A is an alkali metal, alkali-earth metal, transition metal, semimetal or metalloid and x and y are stoichiometric coefficients;
(h) ternary nitrides of type AₓB_{y}N_{z}, where A and B are any combination of alkali metal, alkali-earth metal, transition metal, semimetal or metalloid and x, y and z are stoichiometric coefficients;
(i) quaternary nitrides of type A_{w}BₓC_{y}N_{z}, where A, B and C are any combination of alkali metal, alkali-earth metal, transition metal, semimetal or metalloid and w, x, y and z are stoichiometric coefficients;
(j) binary chalcogenides of type AₓB_{y}, where A is an alkali metal, alkali-earth metal, transition metal, semimetal or metalloid, B is a chalcogen and x and y are stoichiometric coefficients;
(k) ternary chalcogenides of type AₓB_{y}C_{z}, where A and B are any combination of alkali metal, alkali-earth metal, transition metal, semimetal or metalloid, C is a chalcogen and x, y and z are stoichiometric coefficients;
(l) quaternary chalcogenides of type A_{w}BₓC_{y}D_{z}, where A, B and C are any combination of alkali metal, alkali-earth metal, transition metal, semimetal or metalloid, D is a chalcogen and w, x, y and z are stoichiometric coefficients;
(m) binary carbides of type AₓC_{y}, where A is an alkali metal, alkali-earth metal, transition metal, semimetal or metalloid and x and y are stoichiometric coefficients;
(n) binary oxyhalides of type AₓB_{y}O_{z}, where A is an alkali metal, alkali-earth metal, transition metal, semimetal or metalloid, B is a halogen and x, y and z are stoichiometric coefficients;
(o) binary arsenides of type AₓAs_{y}, where A is an alkali metal, alkali-earth metal, transition metal, semimetal or metalloid and x and y are stoichiometric coefficients;
(p) ternary arsenides of type AₓB_{y}As_{z}, where A and B are any combination of alkali metal, alkali-earth metal, transition metal, semimetal or metalloid and x, y and z are stoichiometric coefficients;
(q) quaternary arsenides of type A_{w}BₓC_{y}As_{z}, where A, B and C are any combination of alkali metal, alkali-earth metal, transition metal, semimetal or metalloid and w, x, y and z are stoichiometric coefficients;
(r) binary phosphates of type Aₓ(PO₄)_{y}, where A is an alkali metal, alkali-earth metal, transition metal, semimetal or metalloid and x and y are stoichiometric coefficients;
(s) ternary phosphates of type AₓB_{y}(PO₄)_{z}, where A and B are any combination of alkali metal, alkali-earth metal, transition metal, semimetal or metalloid and x, y and z are stoichiometric coefficients; and
(t) quaternary phosphates of type A_{w}BₓC_{y}(PO₄)_{z}, where A, B and C are any combination of alkali metal, alkali-earth metal, transition metal, semimetal or metalloid and w, x, y and z are stoichiometric coefficients.
(u) metals of type M where M is an alkali metal, alkali-earth metal, transition metal, semimetal or metalloid.

In certain aspects, the present disclosure relates to a solution-phase electrodeposition method for generating an artificial solid-electrolyte interphase (“SEI”) layer onto the surface of a fully-formed, uncoated lithium-ion battery electrode to produce a coated lithium-ion battery electrode, the method comprising (a) transferring, by a roll-to-roll conveyance apparatus, the fully-formed, uncoated lithium-ion battery electrode to an electrodeposition chamber containing a liquid solution comprising an at least first reagent and an electrolyte; (b) exposing the fully-formed, uncoated lithium-ion battery electrode to the liquid solution in the electrodeposition chamber; and (c) applying a voltage or current to the fully-formed, uncoated lithium-ion battery electrode relative to a counter electrode exposed to the liquid solution for a predetermined amount of time, thereby generating the coated battery electrode comprising the artificial SEI layer.

In certain aspects, the present disclosure relates to a battery comprising an artificial SEI produced by any of the solution-phase electrodeposition methods and/or systems disclosed herein. In certain embodiments, the battery is a lithium-ion battery.

In certain aspects, the present disclosure relates to a solution-phase electrodeposition system for generating an artificial SEI onto the surface of a battery electrode, the system comprising a conveyance apparatus for conveying the battery electrode to an electrodeposition chamber containing a liquid solution comprising at least a first reagent and an electrolyte; a counter electrode contained within the electrodeposition chamber that is exposed to the liquid solution; and an electrical source for producing voltage or current required for generating the artificial SEI, wherein the electrical source is in contact with the battery electrode and the counter electrode.

In some embodiments, the battery electrode is a fully-formed battery electrode prior to being conveyed into the electrodeposition chamber. In certain embodiments, the conveyance apparatus of the system is a roll-to-roll apparatus. In certain embodiments, the system further comprises a reference electrode contained within the electrodeposition chamber that is exposed to the liquid solution. In certain embodiments, the system further comprises a thermal chamber, such as an oven.

### BRIEF DESCRIPTION OF THE DRAWINGS

FIG. 1 is an illustration of a battery electrode coated with an artificial SEI in accordance with the present disclosure.

FIG. 2 is a schematic drawing of an embodiment for coating an artificial SEI onto the surface of a battery electrode via electrodeposition in accordance with the disclosure.

FIG. 3 is a schematic drawing of an embodiment for coating an artificial SEI onto the surface of a battery electrode via electrodeposition using a reference electrode in accordance with the disclosure.

FIG. 4 is a schematic drawing of an embodiment for coating an artificial SEI onto the surface of a battery electrode via electrodeposition using multiple chambers in accordance with the disclosure.

### DETAILED DESCRIPTION

The present disclosure provides liquid/solution-phase electrodeposition methods and systems for forming artificial solid-electrolyte interphase (“SEI”) coatings on electrodes. To date, techniques for forming conformal coatings of thin films (<10 micrometer (μm) thickness) on substrates such as lithium-ion battery electrodes, which possess a microstructure comprising a high degree of porosity, tortuosity and/or large number of high aspect ratio features (i.e., “non-planar” microstructure) are either ineffective (“line of sight” limitation of physical vapor deposition) or are costly and time-consuming (traditional Atomic Layer Deposition (ALD)). Embodiments of the present disclosure achieve a cost-effective means for forming uniform, conformal layers on non-planar microstructures.

The method refers generally to a liquid-phase electrodeposition process for the deposition of artificial SEI layers. These thin films may be used to coat the surfaces of components of electrochemical devices such as batteries. In particular, for batteries, such as lithium ion batteries, applications that may benefit with the coatings described herein may include high-voltage cathodes, fast charging, silicon-containing anodes, cheaper electrolytes, and nanostructured electrodes. Thus, in some embodiments, the artificial SEI thin films may be coated onto an electrode of a battery, such as a cathode or anode.

The methods and systems provided herein relate to generating an “artificial SEI” layer in batteries that are more resistant to dissolution than current SEIs, have sufficient adhesion to the material or component to be coated with adequate mechanical stability, are reasonably electrically resistive to prevent electrolyte breakdown while being conductive of ions (as in the case of batteries, for example lithium ions), and are substantially devoid of any particle-to-particle internal resistance.

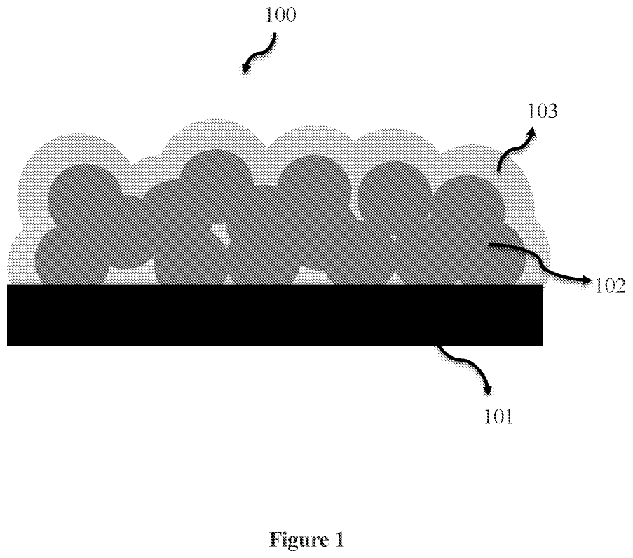

An example of an embodiment of a coated battery electrode in accordance with the present disclosure is shown in FIG. 1. A coated battery electrode, 100, comprises bound electrode constituent active material particles, 102, that are coated with the artificial SEI, 103. The artificial SEI, 103, may be between 0.5 nm to 100 μm thick. The electrode constituent particles, 102, are situated on top of a substrate, 101. In this embodiment, the electrode constituent active material particles, 102, and the substrate, 101, yield a pre-formed electrode.

In some embodiments, an electrode comprises a porous coating of an active material on top of a substrate, such as a foil or a sheet. In some embodiments, the battery electrode comprises graphite, Si, Sn, Ge, Al, P, Zn, Ga, As, Cd, In, Sb, Pb, Bi, SiO, SnO₂, a Si-graphite composite, a Sn-graphite composite or lithium metal. In some cases, the battery electrode comprises LiNiₓMn_{y}CoₓO₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

In certain embodiments, the substrate may be a continuous substrate, typically in the form of a foil or sheet. A “continuous substrate” as used herein refers to a substrate that possesses an aspect ratio of at least 10:1 between its two largest dimensions, and is sufficiently flexible so as to be wound onto itself in the form of a roll. It may be made up of various materials, including but not limited to metal, such as copper, aluminum, or stainless steel, or an organic material, such as polyimide, polyethylene, polyether ether ketone (PEEK), or polyester, polyethylene napthalate (PEN).

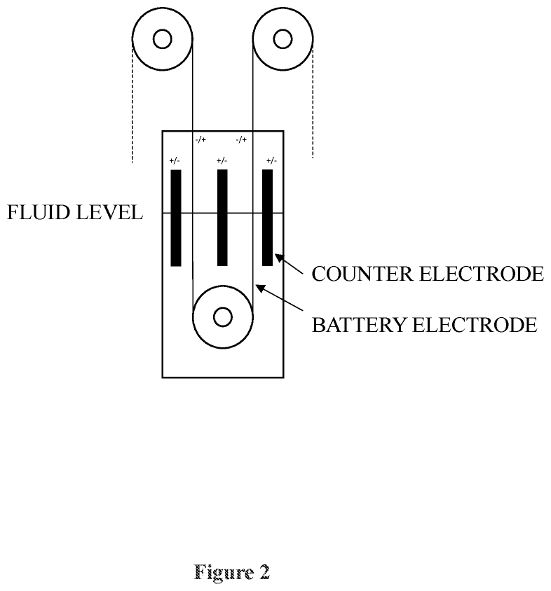

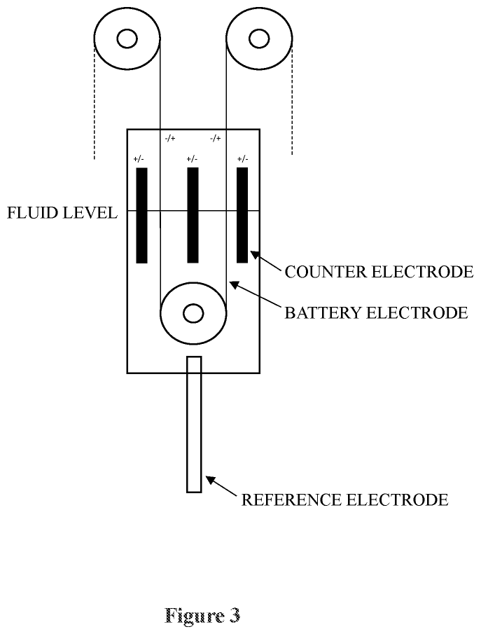

A simple schematic for an embodiment of the method in accordance with the disclosure is shown in FIG. 2. While the embodiment of FIG. 2 is related to a method for coating an artificial SEI onto the surface of a battery electrode, this description is only representative of a component to be deposited using the methods and systems provided herein and is not to be construed as being limited in any way. Referring to FIG. 2, a battery electrode, for example, may be exposed to a fluid in an electrodeposition chamber or tank. The chamber or tank further comprises one or more counter electrodes. Multiple counter electrodes may be employed to improve uniformity of electric field between counter electrodes and battery electrode. Typically, the battery electrode is polarized oppositely relative to counter electrode. The battery and counter electrodes may be polarized positively or negatively relative to each other depending on whether species in tank is anionic or cationic. When both cationic and anionic species are present in the chamber or tank, relative polarity between the battery and counter electrodes may be swept from positive to negative and back again, as in a typical cyclic voltammograrn, to sequentially react cationic and anionic species in order to precipitate artificial SET on the battery electrode surface. In some embodiments, both cationic and anionic components of the resulting artificial SET may deposit and react to form the artificial SET at or near the same voltage or current versus a counter electrode; such a process is said to occur potentiostatically or galvanostatically, respectively. In some embodiments, the electrodeposition chamber or tank may further comprise a reference electrode, as shown in FIG. 3. Reference electrodes may be employed in order to individually define the voltage of either the battery electrode or the counter electrode against an electrochemically non-participating electrode.

The liquid solution comprises at least a first reagent. The first reagent may comprise any compound or element that is able to be electrodeposited on the surface of a lithium-ion battery electrode. In certain embodiments, the first reagent is a metalorganic compound. Examples of such metalorganics include, but are not limited to, aluminum tri-sec butoxide, titanium ethoxide, niobium ethoxide, trimethyl aluminum, and zirconium tert-butoxide. In another embodiment, the first reagent comprises an aqueous solution comprising an ionic compound. Examples include, but are not limited to, zinc acetate, cadmium chloride, zinc chloride, zirconium chloride, selenium oxide and zinc sulfate. In some embodiments, the first solution may vary in pH. In some embodiments, the liquid solution may be a solution including ionic compounds of both cationic and anionic precursors that react to form a solid film (the artificial SEI); in this case the film growth is limited by the kinetics of the film-forming reaction. In some embodiments, the liquid solution may be a solution including both metalorganic and oxidizing precursors that react to form a solid film; in this case the film growth is limited by the kinetics of the film-forming reaction.

In certain embodiments, the kinetics of the electrodeposition artificial SEI-forming reaction is controlled galvanostatically by limiting the electrical current passing between the battery electrode substrate, counter electrode and electrolyte. In certain embodiments, the kinetics of the electrodeposition artificial SEI-forming reaction is controlled potentiostatically by holding the voltage of the battery electrode substrate, relative to the counter electrode, constant at some pre-determined value.

In certain embodiments, the liquid solution may also comprise a solvent that is used to dissolve or complex the first reagent. Preferred solvents include organic solvents, such as an alcohol, for example, isopropyl alcohol or ethanol, alcohol derivatives such as 2-methoxyethanol, slightly less polar organic solvents such as pyridine or tetrahydrofuran (THF), nonpolar organic solvents such as hexane and toluene, water, or an ionic liquid comprising ions including, but not limited to, methylimidazolium and pyridinium.

The electrode is exposed to the liquid solution for a sufficient time (a “residence time”) so as to allow the first reagent(s) to permeate throughout an electrode's porous network, followed by electrodeposition onto an electrode surface in order to generate a continuous layer. Examples of process variables that may influence the electrodeposition process include solution and electrode temperature, residence time, reagent concentration, pH, voltage and current.

The battery electrode is exposed to a voltage or current in the liquid solution for a predetermined amount of time for the solid-precipitating reaction to occur. In some embodiments, the predetermined amount of time may be at least 5 seconds, 10 seconds, 30 seconds, 1 minute, 2, minutes, 5 minutes, 10 minutes, 15 minutes, 20 minutes, 25, minutes, 30 minutes, 45 minutes, 1 hour, or more.

In one embodiment, the liquid solution is contained within a reaction chamber. The reaction chamber must be a device large enough to accommodate receiving the electrode and to contain the amount of liquid solution to be used in electrodeposition reaction. In some embodiments, the system or method may comprise multiple electrodeposition reaction chambers. Such devices that may be used as the reaction chamber include, but are not limited to, tanks, baths, trays, beakers, or the like.

In other embodiments, the compound formed as part of the artificial SEI may comprise Transition Metal Dichalcogenides (TMDs). Typical examples of this class of materials follow the general chemical formula MX₂, where M is a transition metal such as Mo, W, Ti, etc., and X is either S or Se.

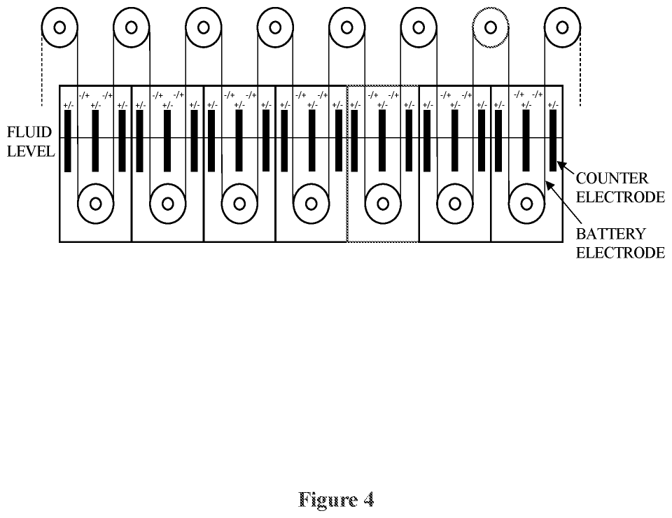

Multiple sequential or repeated steps of the same process can be performed with the same or different solutions. Solutions may be separated (as in first solution, second solution, etc.) to avoid cross-contamination, for instance, or to prevent homogenous nucleation when a heterogeneous film-forming reaction is preferred. An embodiment comprises the use of multiple electrodeposition chambers or tanks used in sequence is shown in FIG. 4, where the battery electrode is passed from one chamber or tank to the next by a conveyance apparatus (shown in the figure as a roll-to-roll system).

It is to be understood that the various steps of the methods disclosed herein may be carried out by a system. The system may include a conveyance apparatus, reaction and/or rinsing chambers, filtration devices, a thermal chamber, a computer to control and/or automate the system, an electrical source for producing the voltage or current needed to carry out the electrodeposition, and monitoring devices, such as ion-selective electrodes or float sensors. The conveyance apparatus is preferably automated and, in some embodiments, comprises a series of rollers, such as tensioning rollers, positioned in such a manner as to guide or direct the electrode into and out of the chambers. In this way, the system can provide for a continuous liquid electrodeposition process for coating an artificial SEI thin film onto the surface of an electrode.

### EXAMPLES

### Example 1: Deposition of ZnO

A lithium-ion battery electrode is conveyed into an electrodeposition chamber, where it is submerged in an aqueous solution containing 0.1M Zn(NO₃)₂. A Pt wire counter electrode is also submerged in the solution. The temperature of the solution is adjusted to be 70 degrees Celsius. A ZnO artificial SEI is electrodeposited onto the lithium-ion battery electrode from the aforementioned precursor, galvanostatically, by maintaining a constant current of −7 mA/cm² between the battery electrode and counter electrode. The current is also pulsed on and off at a rate of once every 0.02 seconds.

### Example 2: Deposition of Al metal

A lithium-ion battery electrode is conveyed into an electrodeposition chamber, wherein it is submerged in a solution of AlCl₃ in DMSO. A Pt wire counter electrode is also submerged in the solution. The temperature of the solution is adjusted to be 130 degrees Celsius. An Al metal artificial SEI is electrodeposited onto the lithium-ion battery electrode from the aforementioned precursor, galvanostatically, by maintaining a constant current of −5 mA/cm² between the battery electrode and counter electrode. After deposition of the Al metal film, the electrode may be thermally treated in an oxygen plasma in order to convert the metal to amorphous aluminum oxide.

### Example 3: Deposition of CdSe

A lithium-ion battery electrode is conveyed into an electrodeposition chamber, wherein it is submerged in an aqueous solution containing SeO₂, CdSO₄ and sulfuric acid. A Pt wire counter electrode is also submerged in the solution. The pH of the resulting solution is adjusted to be approximately 3. The temperature of the solution is adjusted to be 60 degrees Celsius. A CdSe artificial SEI is electrodeposited onto the lithium-ion battery electrode from the aforementioned precursors, galvanostatically, by maintaining a constant current of −1.5 mA/cm² between the battery electrode and counter electrode.

It should be understood from the foregoing that, while particular implementations have been illustrated and described, various modifications can be made thereto and are contemplated herein. It is also not intended that the present disclosure be limited by the specific examples provided within the specification. While certain embodiments have been described with reference to the aforementioned specification, the descriptions and illustrations of the preferable embodiments herein are not meant to be construed in a limiting sense. Furthermore, it shall be understood that all aspects of the present disclosure are not limited to the specific depictions, configurations or relative proportions set forth herein which depend upon a variety of conditions and variables. Various modifications in form and detail of the embodiments will be apparent to a person skilled in the art. It is therefore contemplated that the present disclosure shall also cover any such modifications, variations and equivalents.

1. A method for electrodepositing an artificial solid-electrolyte interphase (“SEI”) coating onto the surface of a battery electrode to produce a coated battery electrode, the method comprising:
(a) providing the battery electrode onto a conveyance apparatus;
(b) transferring, by the conveyance apparatus, the battery electrode to an electrodeposition chamber containing a liquid solution comprising an at least first reagent;
(c) exposing the battery electrode to the liquid solution in the electrodeposition chamber; and
(d) applying a voltage or current to the battery electrode relative to a counter electrode exposed to the liquid solution for a predetermined amount of time, thereby yielding the coated. battery electrode comprising the artificial SEI coating.

2. The method of claim 1, wherein:
the artificial SEI coating has a thickness from about 0.5 nm to 100 μm,
the battery electrode in (a) has a thickness of 100 nm to 1,000 μm,
the battery electrode in (a) has pores ranging in size of 0.1 nm to 100 μm, and
the battery electrode in (a) has a film porosity of 1-99%,

3-5. (canceled)

6. The method of any of the preceding claims claim 1, wherein the battery electrode in (a) is composed of graphite, Si, Sn, Ge, Al, P, Zn, Ga, As, Cd, In, Sb, Pb, Bi, SiO, SnO₂, a Si-graphite composite, a Sn-graphite composite or lithium metal.

7. The method of claim 1, wherein the battery electrode in (a) is composed of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

8. The method of claim 1, wherein the conveyance apparatus comprises a series of rollers for guiding the battery electrode into the electrodeposition chamber.

9. (canceled)

10. The method of claim 1, wherein the battery electrode is composed of an active material that is deposited on a continuous substrate.

11-14. (canceled)

15. The method of claim 10, wherein the substrate is made up of an organic material selected from the group consisting of polyimide, polyethylene, polyether ether ketone (PEEK), polyester, and polyethylene napthalate (PEN).

16. The method of claim 10, wherein the substrate is made up of a metal comprising at least one of copper, aluminum, or stainless steel.

17. (canceled)

18. (canceled)

19. The method of claim 1, further comprising:
rinsing the coated battery electrode post-deposition with a rinsing solution comprising at least a solvent; and
exposing the coated battery electrode to a thermal treatment in the presence of an ambient gas mixture, wherein the ambient gas mixture comprises at least one of O₂, ozone, N₂, or Ar.

20. (canceled)

21. (canceled)

22. The method of claim 19, wherein the coated battery electrode is heated to temperatures up to 300 degrees Celsius.

23. The method of claim 1, further comprising exposing the coated battery electrode to a thermal treatment in the presence of gases or a plasma prior to artificial SEI coating via electrodeposition, wherein the plasma comprises at least one of oxygen, argon, hydrogen, or nitrogen.

24. (canceled)

25. (canceled)

26. The method of claim 1, wherein:
the liquid solution comprises an electrolyte,
the electrolyte comprises a solvent and a salt
the solvent comprises an organic solvent, an ionic liquid water, or a mixture of these, and
the salt comprises a lithium-containing; compound.

27. (canceled)

28. The method of claim 26, wherein the lithium-containing compound is LiClO₄.

29. (canceled)

30. The method of claim 26, wherein the electrolyte comprises a solvent and artificial SEI forming reactants.

31. The method of claim 1, wherein artificial SEI coating comprises a compound selected from one of the following groups:
(a) binary oxides of type AₓO_{y}, where A is an alkali metal, alkali-earth metal, transition metal, semi metal or metalloid and x and y are stoichiometric coefficients;
(b) ternary oxides of type AₓB_{y}O_{z}, where A and B are any combination of alkali metal, alkali-earth metal, transition metal, semimetal or metalloid and x, y and z are stoichiometric coefficients:
(c) quaternary oxides of type A_{w}BₓC_{y}O_{z} where A, B and C are any combination of alkali metal, alkali-earth metal, transition metal, semimetal or metalloid and w, x, y and z are stoichiometric coefficients;
(d) binary halides of type AₓB_{y}, where A is an alkali metal, alkali-earth metal, transition metal, semimetal or metalloid, B is a halogen and x and y are stoichiometric coefficients;
(e) ternary halides of type AₓB_{y}C_{z}, where A and B are any combination of alkali metal, alkali-earth metal, transition metal, semimetal or metalloid, C is a halogen and x, y and z are stoichiometric coefficients;
(f) quaternary halides of type A_{w}BₓC_{y}D_{z}, where A, B and C are any combination of alkali metal, alkali-earth metal, transition metal, semimetal or metalloid, D is a halogen and w, x, y and z are stoichiometric coefficients;
(g) binary nitrides of type AₓN_{y}, where A is an alkali metal, alkali-earth metal, transition metal, semimetal or metalloid and x and y are stoichiometric coefficients;
(h) ternary nitrides of type AₓB_{y}N_{z}, where A and B are any combination of alkali metal, alkali-earth metal, transition metal, semimetal or metalloid and x, y and z are stoichiometric coefficients;
(i) quaternary nitrides of type A_{w}BₓC_{y}N_{z}, where A, B and C are any combination of alkali metal, alkali-earth metal, transition metal, semimetal or metalloid and w, x, y and z are stoichiometric coefficients:
(j) binary chalcogenides of type AₓB_{y}, where A is an alkali metal, alkali-earth metal, transition metal, semimetal or metalloid, B is a chalcogen and x and y are stoichiometric coefficients,
(k) ternary chalcogenides of type AₓB_{y}C_{z}, where A and B are any combination of alkali metal, alkali-earth metal, transition metal, semimetal or metalloid, C is a chalcogen and x, v and z are stoichiometric coefficients;
(l) quaternary chalcogenides of type A_{w}BₓC_{y}D_{z}, where A, B and C are any combination of alkali metal, alkali-earth metal, transition metal, semimetal or metalloid, B is a chalcogen and w, x, y and z are stoichiometric coefficients;
(m) binary carbides of type AₓC_{y}, where A is an alkali metal, alkali-earth metal, transition metal, semimetal or metalloid and x and y are stoichiometric coefficients;
(n) binary oxyhalides of type AₓB_{y}O_{z}, where A is an alkali metal, alkali-earth metal, transition metal, semimetal or metalloid, B is a halogen and x, y and z are stoichiometric coefficients;
(o) binary arsenides of type AₓAs_{y}, where A is an alkali metal, alkali-earth metal, transition metal, semimetal or metalloid and x and y are stoichiometric coefficients;
(p) ternary- arsenides of type AₓB_{y}As_{z}, where A and B are any combination of alkali metal, alkali-earth metal, transition metal, semimetal or metalloid and x, y and z are stoichiometric coefficients:
(q) quaternary arsenides of type A_{w}BₓC_{y}As_{z}, where A, B and C are any combination of alkali metal, alkali-earth metal, transition metal, semimetal or metalloid and w, x, y and z are stoichiometric coefficients;
(r) binary phosphates of type Aₓ(PO₄)_{y}, where A is an alkali metal, alkali-earth metal, transition metal, semimetal or metalloid and x and y are stoichiometric coefficients;
(s) ternary phosphates of type AₓB_{y}(PO₄)_{z}, where A and B are any combination of alkali metal, alkali-earth metal, transition metal, semimetal or metalloid and x, y and z are stoichiometric coefficients;
(t) quaternary phosphates of type A_{w}BₓC_{y}(PO₄)_{z}, where A, B and C are any combination of alkali metal, alkali-earth metal, transition metal, semimetal or metalloid and w, x, y and z are stoichiometric coefficients; and
(u) metals of type M where M is an alkali metal, alkali-earth metal, transition metal, semimetal or metalloid.

32. The method of claim 1, wherein a plurality of unique artificial SEI is grown sequentially via electrodeposition as a stack on the surface of the battery electrode by repeating (a)-(d).

33. (canceled)

34. The method of claim 1, wherein the predetermined amount of time is at least 5 seconds, 10 seconds, 30 seconds, 1 minute, 2, minutes, 5 minutes, 10 minutes, 15 minutes, 20 minutes, 25, minutes, 30 minutes, 45 minutes, or 1 hour.

35. The method of claim 34, wherein the predetermined amount of time is selected to allow for a solid-precipitating reaction to occur on the surface of the battery electrode.

36. The method of claim 1, wherein the battery electrode in (a) is a fully-formed battery electrode.

37. (canceled)

38. A solution-phase electrodeposition system for generating an artificial SEI onto the surface of a battery electrode, the system comprising:
a conveyance apparatus for conveying the battery electrode to an electrodeposition chamber containing a liquid solution comprising at least a first reagent and an electrolyte:
a counter electrode contained within the electrodeposition chamber that is exposed to the liquid solution, and
an electrical source for producing voltage or current required for generating the artificial SEI, wherein the electrical source is in contact with the battery electrode and the counter electrode.

39. (canceled)

40. The system of claim 38, comprising a thermal chamber and a reference electrode contained within the electrodeposition chamber that is exposed to the liquid solution, and wherein the conveyance apparatus is a roll-to-roll apparatus.

41-43. (canceled)
